(19) United States
(12) Patent Application Publication
(10) Pub. No.: US 2017/0356475 A1
(43) Pub. Date: Dec. 14, 2017

(54) VENTILINSEL-BASISMODUL UND VENTILINSEL

(71) Applicant: BUERKERT WERKE GMBH & CO. KG, Ingelfingen (DE)

(72) Inventors: Thomas HAMM, Ingelfingen (DE); Marc FISCHER, Kuenzelsau (DE)

(21) Appl. No.: 15/620,122

(22) Filed: Jun. 12, 2017

(30) Foreign Application Priority Data
Jun. 14, 2016 (DE) 102016110909.6

(51) Int. Cl. F15B 20/00; F16K 31/06

(52) U.S. Cl. CPC F15B 20/002; F16K 31/0675

(57) ABSTRACT

There is described a valve island base module (12, 14) with at least one valve module receptacle (25a-25h), which comprises means for the attachment of a plurality of valve modules (18a-18h) each including at least one electrically actuatable valve on the valve island base module (12, 14). In addition, the valve island base module (12, 14) has a fluidic and an electrical valve module connection (36a-36h) for the power supply of the valve modules (18a-18h) with electric current. A power supply line (30) is electrically connected with the electrical valve module connections (36a-36h). By means of a safety interface (26, 28) accessible from outside, the power supply of at least one electrical valve module connection (36a-36h) can selectively be interrupted. In addition, there is described a valve island (10) with at least one valve island base module (12, 14) and at least one valve module (18a-18h).

This invention relates to a valve island base module.

In addition, this invention relates to a valve island.

Valves, valve islands and valve island base modules are used in many fields of process and manufacturing automation. Valves of a valve island and the valve island itself typically are controlled via a field bus or by an individual connection. In numerous applications it is necessary to at least sectionally safely shut off the valves and/or the valve island or to put them into a safe operating condition in the case of an incorrect actuation or a potentially unsafe system condition. For example, this may be necessary during malfunctions, maintenance work or upon actuation of an emergency-off switch.

Against this background a solenoid valve module, which also is referred to as actuating drive, with a safety circuit is known from DE 20 2013 007 990 U1. In the case of an incorrect actuation of the actuating drive the same can be shut off. The safety circuit is directly connected to the solenoid valve module or the actuating drive comprising at least one solenoid valve via an electrical connection. In valve islands, such solenoid valve modules can replace standard valve modules without safety circuit.

Against a similar background a module arrangement is known from EP 2 026 156 B1, which also can be referred to as valve island. The module arrangement comprises valve modules, control modules and at least one safety module. The safety module can have valve and/or control modules associated thereto. The safety module is designed such that it can interrupt the power supply of associated modules. Such safety modules can be integrated into existing valve islands without safety circuit by corresponding reconstruction measures.

From DE 11 2013 002 370 T5 there is furthermore known an electromagnetic valve system which can execute a safety function. The safety function is realized by safety switches with which the power supply to selected valve units can be interrupted. The safety switches can be arranged in a control unit and interrupt the power supply to valves which are associated to the control unit. Alternatively, the safety switches are arranged in a valve. They can then interrupt the power supply to this valve and to valves associated to this valve.

It is the object of the present invention to further improve valve islands with safety circuits. In particular, it should be possible to use standard valve modules in the valve island.

The object is solved by a valve island base module with at least one valve module receptacle, which comprises means for the attachment of a plurality of valve modules each including at least one electrically actuatable valve to the valve island base module and a fluidic as well as an electrical valve module connection for the power supply of the valve modules with electric current, a power supply line which is electrically connected with the electrical valve module connections, and a safety interface accessible from outside, which is formed to selectively interrupt the power supply of at least one electrical valve module connection. Preferably, the valve island base module comprises two, four or eight valve module receptacles for accommodating a corresponding number of valve modules. Due to the arrangement of the safety interface on the valve island base module, standard valves, i.e. valves without safety circuit, can be used on the same. It thereby also is easily possible to retrofit safety assemblies or circuits. From a fluidic and electrical point of view, these valves are connected in parallel, when they are arranged on the valve island base module. Useful electrically actuatable valves include e.g. electromagnetic control valves or piezoelectric valves. Preferably, the safety interface is arranged on an external surface of the valve island base module, so that the safety interface is easily accessible from outside. This facilitates the assembly, maintenance and repair of safety assemblies and/or circuits. The safety circuit also is independent of the control of the valve island base module. This means that even in the case of an interruption of the power supply by the safety interface, the controller of the valve island base module still is operable. In addition, the safety interface can be associated to different groups of valve modules.

According to one embodiment, at least one bus line extends in the valve island base module, which is equipped to control valve modules attached to the valve module receptacle. Bus lines by default are used to control valve modules. Thus, the valve island base module can be coupled with a plurality of different valve modules.

Preferably, the valve island base module comprises a module control unit which is equipped to control valve modules attached to the valve module receptacle, and preferably can be coupled with a superordinate control unit via a bus line. Certain control tasks thus can be executed in the valve island base module. Via the superordinate control unit the activities of the valve island can be coordinated in a wider context.

One design variant provides that the valve module connections are electrically connectable with the power supply line via switching means integrated in the base module and the supply of electrical power selectively can be interrupted by the switching means. The switching means preferably are controlled by the module control unit. Thus, in operation of the valve island, more exactly of the valve island base module, individual valve module connections and thus individual valve modules can be cut off from the power supply. The switching means preferably are arranged in branch lines, which extend between a valve module connection and a power supply line continuously extending in a line-up direction of the valve modules.

The safety interface, the switching means and the valve module connection can electrically be connected in series. The safety interface, the switching means and the valve module connection hence are linked with a logical AND. This means that at the valve module connection power only is available when the safety interface and the switching means are closed in a manner to conduct electricity. Otherwise, there is no power to the valve module connection. This guarantees a safe operation of the valve module connection and of the valve module connected thereto.

In one embodiment, the safety interface comprises a safety connection which is coupled with the power supply line integrated in the valve island base module, wherein a safety element, preferably a bridge, a relay, a switch or a switchingly acting semiconductor element is connectable to the safety connection. For example, the safety element can be a transistor. Via the safety connection, the safety element can easily be exchanged and connected. For the case that a bridge is used, the safety function can be bridged electrically. A safety element always is a group of valve module connections and thus associated to a group of valve modules, which then possibly are de-energized by the safety element. The safety connection preferably includes terminal or plug connections. Thus, a simple and intuitive connection of the safety elements is possible, also in the field.

Preferably, the safety connections are arranged in the vicinity of the associated valve module connections.

In one variant, the valve island base module comprises at least two safety interfaces, wherein the safety interfaces each are formed to selectively interrupt the power supply of a partial quantity of the valve module connections. Different partial quantities of valve module connections and different partial quantities of the valve modules on a valve island can be associated to different safety circuits. Interleaving of the safety circuits likewise is possible. The safety circuit thereby can easily be adapted to the circumstances of an application. In addition, a high operational safety of the valve island base module thus is given. Individual valve module connections and thus individual valve modules also can be associated to a plurality of safety circuits. A special case is the allocation of one safety interface per valve module connection. In addition, for example, in the case of eight valve module connections two safety interfaces can be used for four valve module connections each.

Advantageously, the safety interface is spaced from the valve module receptacle and preferably arranged on a side of the valve island base module opposite to the valve module receptacle. This ensures an easy accessibility of the safety interface. An exchange of a safety element connected to the safety interface hence is possible without much effort.

In the valve island base module fluidic supply channels also can be arranged, which are formed for a fluidic supply of the valve modules and have interfaces to the valve modules. The supply channels preferably extend along a line-up direction of the valve modules.

In a preferred embodiment, the valve island base module comprises a diagnostic means which can detect a state of the safety interface. In particular, it can thus be detected whether or not an electric circuit has been interrupted by the safety interface. Hence, condition monitoring is realized.

Preferably, the diagnostic means is coupled with a display means for indicating a state of the safety interface, and the display means preferably is arranged on the valve island base module. The display module indicates states of the safety interface in a manner which is easily detectable by an operator. The display can be arranged on the valve module, the valve island base module or a control module.

According to one design alternative, the power supply line and the safety interface are formed such and the valve modules are coupled thereto such that the display means and/or the module control unit can still be operated when the valve module is shut off or when valve modules are shut off. The power supply of the display means and/or of the module control unit thus is not influenced by the states of the safety interface. This ensures an indication which also works in a case of fault. The valve island base module and hence the valve island thus likewise can be actuated at any time.

The valve island base module also can be of multi-part design and preferably comprise a fluidic portion, an electrical portion and a connecting portion. In this way, a particularly simple, clear and robust construction of the valve island base module is achieved.

Preferably, the electrically actuatable valve comprises a coil.

In a preferred embodiment, a safety element is connected to the safety interface of the valve island base module, wherein the safety element preferably is a bridge, a relay, a switch or a switchingly acting semiconductor element. Thus, a safe operation of the valve island base module and a valve island equipped therewith is possible. The safety element can be arranged on the valve island base module, on the valve island or at another suitable point in the machine or system equipped with the valve island base module.

In addition, the object is solved by a valve island with at least one valve island base module as mentioned above, wherein at least one valve module is connected to the valve island base module.

According to one embodiment of the valve island, the valve island base module is coupled with a control module, wherein in the control module a superordinate control unit preferably is arranged, which is coupled with the valve island base module by means of a bus line.

On a bottom side facing the valve island base module, the valve modules include the electrical valve module connections, an outlet for fluid and in addition an interface as fluid inlet. Thus, the electrical system, fluid inlet and fluid outlet each can be coupled on one side.

The valve modules usually have a cuboid shape and the valve island base modules have an L-shape in a side view.

The invention will be explained below with reference to the attached Figures, in which:

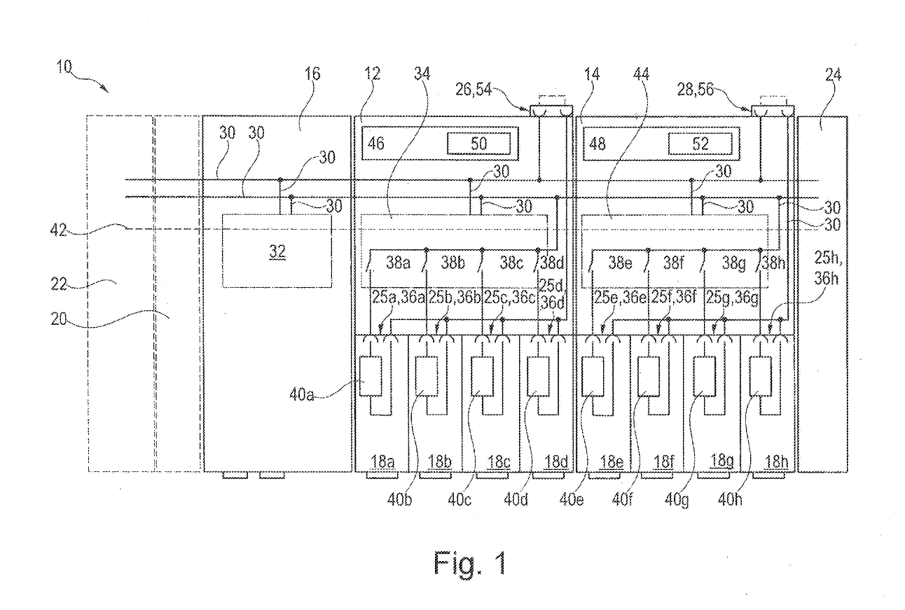

FIG. 1 shows a valve island according to the invention with a valve island base module according to the invention,

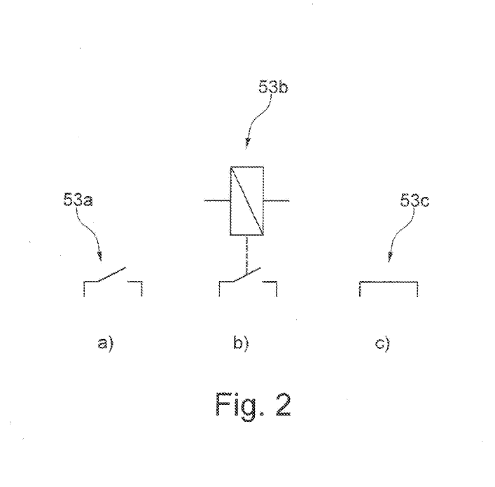

FIG. 2 shows exemplary safety elements which can be connected to a safety interface of a valve island base module according to the invention, and

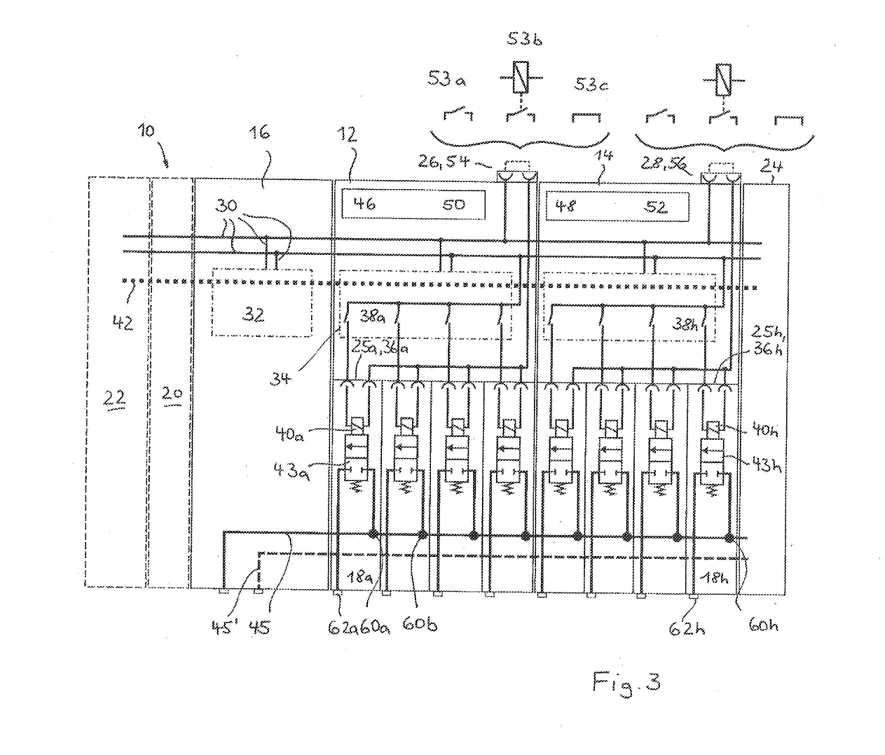

FIG. 3 shows the valve island in the embodiment according to FIG. 1 with indicated valves.

FIG. 1 shows a valve island 10 which is composed of several modules. It comprises a first valve island base module 12, a second valve island base module 14, a control module 16 and valve modules 18a to 18h. All modules are prefabricated, separate construction units which can be coupled to and decoupled from other modules.

The valve island 10 can also comprise further modules, as is indicated by the additional modules 20, 22 and 24 represented without any further details.

The control module 16 is coupled with the additional module 20 and the first valve island base module 12.

The first valve island base module 12 is coupled with the valve modules 18a to 18d and with the second valve island base module 14. The valve modules 18a to 18d are attached to the valve island base module 12 via valve module receptacles 25a to 25d. The second valve island base module 14 has the valve modules 18e to 18h coupled thereto. The same are attached to the valve island base module 14 via valve module receptacles 25e to 25h.

In addition, the additional module 24 is coupled to the second valve island base module 14.

On the first valve island base module 12 there is also arranged a safety interface 26, and on the second valve island base module 14 a safety interface 28 is arranged.

In the valve island base modules 12, 14 non-illustrated fluidic supply channels are arranged, which serve the fluidic supply of the valve modules 18a to 18h.

The valve modules 18a to 18h therefor are connected with the supply channels via a non-illustrated fluidic valve module connection which forms the interface between the valve modules 18a to 18h and the respectively associated valve island base module 12, 14.

In a non-illustrated embodiment, the valve island base modules 12, 14 also can have a multipart design. Then, they comprise a fluidic and an electrical portion as well as a connecting portion.

The power supply of the control module 16, the valve island base modules 12, 14 and the valve modules 18a to 18h is effected via a power supply line 30.

In the control module 16, the power supply line 30 feeds a superordinate control unit 32 with electric current. In the first valve island base module 12 the power supply line 30 supplies a module control unit 34 with electric current.

In addition, the power supply line 30 is designed such that it passes through the safety interface 26. The power supply line 30 comprises several branch lines.

The valve modules 18a to 18d, which are connected to the first valve island base module 12, each are supplied with current via an associated electrical valve module connection 36a to 36d.

In addition, a switching means 38a to 38d in the form of an electric switch is associated to each of the valve module connections 36a to 36d, so that the power supply selectively can be interrupted.

Thus, the safety interface 26, the switching means 38a to 38d and the valve module connections 36a to 36d are electrically connected in series. Consequently, the coils 40a to 40d connected to the valve module connections 36a to 36d also are connected in series with these components.

As regards the power supply via the power supply line 30, the second valve island base module 14 is constructed analogous to the valve island base module 12, which is why this will no longer be discussed separately. The reference numerals correspondingly are provided with the letters e to h.

The valve modules 18a to 18h are supplied with current via the electrical valve module connections 36a to 36h and each comprise a coil 40a to 40h which is part of an electromagnetic control valve for selectively interrupting a fluid flow. The electromagnetic control valves are not shown in detail in FIG. 1, but merely are symbolized by the coils 40a to 40h.

The valve island base modules 12, 14 for example in a side view (as seen from the left or right in FIG. 1) are L-shaped bodies, with a vertical leg protruding from a base leg. In the top view according to FIG. 1, as seen from the upper edge, the vertical leg extends up to before the valve module connections 36a to 36h. Before the valve module connections 36a to 36h a shoulder extending downwards to the vertical leg is present, which then transitions into an upper side of the horizontal leg. The valve modules 18a to 18h are inserted into the shoulder which forms the valve module receptacles 25a to 25h.

On the upper side of the valve module receptacles 25a to 25h, i.e. of the vertical leg, the valve module connections 36a to 36h then are provided.

Preferably, these connections are designed as plug connections, so that fast coupling is possible. The control of the valve island 10 is effected via a bus line 42. The same passes through all illustrated modules of the valve island 10, in particular through the control module 16 and the two valve island base modules 12, 14.

Via the bus line 42, the superordinate control unit 32 is coupled with the module control unit 34 of the first valve island base module 12 and with a module control unit 44 of the second valve island base module 14.

Via the bus line 42 the valve modules 18a to 18h, more exactly the electromagnetic control valves 43a to 43h arranged therein, which are symbolized by the coils 40a to 40h, can be controlled.

FIG. 3 shows the electromagnetic control valves 43a to 43h, which are seated in the associated valve modules 18a to 18h and are actuated by the associated coils 40a to 40h. For a better clarity in FIG. 3, only the first and last ones of the rows of coils 40a to 40h arranged side by side and of the control valves 43a to 43h are provided with reference numerals.

A fluid supply line 45 extends through the control module 16 and through the valve island base modules 12, 14, e.g. through the horizontal leg.

On insertion of the valve modules 18a to 18h into the valve module receptacles 25a to 25h, the valve modules 18a to 18h couple to corresponding interfaces 60a to 60h, which e.g. end on the upper side of the valve module receptacles 25a to 25h, for example by means of a safety coupling with check valve.

Between the respective connection 60a to 60h and an outlet 62a to 62h at the valve module 18a to 18h, the associated control valve 43a to 43h then is seated. The outlets 62a to 62h can end on the front side, as shown in FIG. 3, or preferably on the bottom side of the valve modules 18a to 18h, so that their outlet interfaces couple to the upper side of the valve module receptacles 25a to 25h. In the valve island base modules 12, 14 corresponding outlet channels then extend up to the front side pointing downwards in FIG. 3, where they end towards the outside.

Thus, an exactly dosed quantity of fluid can be dispensed by the valve island at each outlet 62a to 62h. Of course, further fluid supply lines 45′ can be provided, which can be coupled to selectively. The fluid supply lines 45′ for example are provided for supplying pilot control valves.

For monitoring states of the valve island base modules 12, 14 and/or the valve modules 18a to 18h, the first valve island base module 12 comprises a first diagnostic means 46, and the second valve island base module 14 comprises a second diagnostic means 48.

The first diagnostic means 46 can comprise a display means 50 by means of which a state of the safety interface 26 can be indicated. In the same way, the diagnostic means 48 comprises a display means 52 by means of which a state of the safety interface 28 can be indicated.

In the illustrated embodiment, the valve island 10 comprises two valve island base modules 12, 14 which each include the safety interface 26, 28.

Alternatively, the valve island base modules 12, 14 can comprise several safety interfaces.

For example, the valve island base modules 12, 14 can be combined to form one single valve island base module. Then, the safety interface 26 still would be associated to the valve modules 18a to 18d, and the safety interface 28 would be associated to the valve modules 18e to 18h and each might interrupt their power supply.

The number of safety interfaces arranged in a valve island base module and their interconnection with the electrical valve module connections can be designed depending on the application.

To the safety interfaces 26, 28 one safety element each is connected, for which by way of example FIG. 2 a) shows a switch 53a, FIG. 2 b) shows a relay 53b, and FIG. 2 c) shows a bridge 53c. Other switchingly acting semiconductor elements, e.g. a transistor, likewise are conceivable as safety element.

The safety elements shown in FIG. 2 are connected to the first valve island base module 12 via a safety connection 54, which is part of the safety interface 26, and to the second valve island base module 14 via a safety connection 56, which is part of the safety interface 28. The safety elements 53a to 53c thereby are coupled with the power supply line 30.

In operation of the valve island 10, the safety interface 26 now can selectively interrupt the power supply of the electrical valve module connections 36a to 36d. This is effected by interrupting the connection at the safety connection 54.

In the illustrated embodiment, the power supply of the valve modules 18a to 18d hence is interrupted.

However, the module control unit 34 still is supplied with current. The diagnostic means 46 and the display means 50 also can still be supplied with current.

The same applies for the base module 14, which is why this will not be discussed here in more detail.

1. A valve island base module (12, 14), with at least one valve module receptacle (25a-25h) which comprises means for the attachment of a plurality of valve modules (18a-18h) each including at least one electrically actuatable valve to the valve island base module (12, 14) and a fluidic as well as an electrical valve module connection (36a-36h) for the power supply of the valve modules (18a-18h) with electric current, a power supply line (30) which is electrically connected with the electrical valve module connections (36a-36h), and a safety interface (26, 28) accessible from outside, which is formed to selectively interrupt the power supply of at least one electrical valve module connection (36a-36h).

2. The valve island base module (12, 14) according to claim 1, characterized in that at least one bus line (42) extends in the valve island base module (12, 14) which bus line is equipped to control valve modules (18a-18h) attached to the valve module receptacle (25a-25h).

3. The valve island base module (12, 14) according to claim 1, characterized in that the valve island base module (12, 14) comprises a module control unit (34, 44) which is equipped to control valve modules (18a-18h) attached to the valve module receptacle (25a-25h) and preferably can be coupled with a superordinate control unit (32) via a bus line (42).

4. The valve island base module (12, 14) according to claim 1, characterized in that the valve module connections (36a-36h) are electrically connectable with the power supply line (30) via switching means (38a-38h) integrated in the valve island base module (12, 14) and the supply of electric current selectively can be interrupted by the switching means (38a-38h).

5. The valve island base module (12, 14) according to claim 4, characterized in that the safety interface (26, 28), the switching means (38a-38h) and the valve module connection (36a-36h) are electrically connected in series and the safety interface (26, 28) is arranged between the power supply line (30) and the coils of the valves (43a-43h).

6. The valve island base module (12, 14) according to claim 1, characterized in that the safety interface comprises a safety connection (54, 56) which is coupled with the power supply line (30) integrated in the valve island base module (12, 14), wherein a safety element, preferably a bridge (53c), a relay (53b), a switch (53a) or a switchingly acting semiconductor element is connectable to the safety connection.

7. The valve island base module (12, 14) according to claim 1, characterized in that it comprises at least two safety interfaces (26, 28), wherein the safety interfaces (26, 28) each are formed to selectively interrupt the power supply of a partial quantity of the valve module connections (36a-36h).

8. The valve island base module (12, 14) according to claim 1, characterized in that the safety interface (26, 28) is spaced from the valve module receptacle (25a-25h).

9. The valve island base module (12, 14) according to claim 8, characterized in that the safety interface (26, 28) is arranged on a side of the valve island base module (12, 14) opposite to the valve module receptacle (25a-25h).

10. The valve island base module (12, 14) according to claim 1, characterized in that in the valve island base module (12, 14) at least one fluidic supply channel (45, 45′) is arranged, which is formed for a fluidic supply of the valve modules (18a-18h) and has interfaces (60a-60h) to the valve modules (18a-18h).

11. The valve island base module (12, 14) according to claim 1, characterized in that it comprises a diagnostic means (46, 48) which can detect a state of the safety interface (26, 28).

12. The valve island base module (12, 14) according to claim 11, characterized in that the diagnostic means (46, 48) is coupled with a display means (50, 52) for indicating a state of the safety interface (26, 28) and the display means (50, 52) preferably is arranged on the valve island base module (12, 14).

13. The valve island base module (12, 14) according to claim 12, characterized in that the power supply line (30) and the safety interface (26, 28) are formed such and the valve modules (18a-18h) are coupled thereto such that the display means (50, 52) and/or the module control unit (34, 44) can still be operated when the valve module (18a-18h) or the valve modules (18a-18h) is/are shut off.

14. The valve island base module (12, 14) according to claim 1, characterized in that it has a multipart design.

15. The valve island base module (12, 14) according to claim 1, characterized in that it comprises a fluidic portion, an electric portion and a connecting portion.

16. The valve island base module (12, 14) according to claim 1, characterized in that the electrically actuatable valve (43a-43h) comprises a coil (40a-40h).

17. The valve island base module (12, 14) according to claim 1, characterized in that a safety element is connected to the safety interface, wherein the safety element preferably is a bridge (53c), a relay (53b), a switch (53a) or a switchingly acting semiconductor element.

18. A valve island (10) with at least one valve island base module (12, 14) according to claim 1, wherein at least one valve module (18a-18h) is connected to the valve island base module (12, 14).

19. The valve island (10) according to claim 18, characterized in that the valve island base module (12, 14) is coupled with a control module (16).

20. The valve island (10) according to claim 19, characterized in that in the control module (16) a superordinate control unit (32) is arranged, which is coupled with the valve island base module (12, 14) by means of a bus line (42).
